(19) United States
(12) Patent Application Publication
(10) Pub. No.: US 2006/0248011 A1
(43) Pub. Date: Nov. 2, 2006

(54) Secure commerce systems

(76) Inventors: Robert Hecht-Nielsen, Del Mar, CA (US); Cheryl St John, Greenbrae, CA (US)

Correspondence Address: FISH & RICHARDSON, PC, P.O. BOX 1022, MINNEAPOLIS, MN, 55440-1022, US

(21) Appl. No.: 11/384,015

(22) Filed: Mar. 17, 2006

Related U.S. Application Data
(60) Provisional application No. 60/675,774, filed on Apr. 27, 2005.

(51) Int. Cl. G06Q 40/00

(52) U.S. Cl. 705/44; 705/39

(57) ABSTRACT

Secure commerce systems and methods are disclosed. Commercial security is first provided by identity verification via voice authentication using voice similarity analysis, and by a set of random, continually-changing passwords that can be encrypted and uniquely identified with a fictitious and anonymous user name. Each anonymous user name is uniquely associated with a consumer's real identity that is protected by a set of security measures of a Knowledge Manager (KM), for use with an Anonymous Payment Card (APC) and an Anonymous Internet-email Account. The KM issues a fictitious, “one-time” (e.g. never re-used) APC number and user name to a participating consumer who wishes to attain anonymity, along with a mailing address at a “Ghost Shipping” location, such that packages sent to the consumer can be re-packaged and re-shipped to the consumer without the seller or the shipper knowing the consumer's real identity.

### CROSS REFERENCE TO RELATED APPLICATIONS

The present application claims priority under 35 U.S.C. §119 to U.S. Provisional Application Ser. No. 60/675,774, filed Apr. 27, 2005, entitled SECURE COMMERCE SYSTEMS. The subject matter and disclosure of the above-noted application is incorporated herein by reference.

### BACKGROUND

With the advent and ubiquity of the Internet, electronic commerce (e-commerce) has substantially replaced many former means of commerce to become the dominant mechanism by which consumers purchase products. Almost anything can be purchased today using an e-commerce platform, including nearly every type of good or service. However, with the increased popularity of e-commerce transactions, the world has seen a dramatic rise in fraud and abuse surrounding these platforms.

Presumably secure networks or secure processes are constantly and continually compromised, placing at risk the data that is exchanged for e-commerce transactions. This data can include financial data, product data, and particularly, consumer data. All of this data represents information, both raw and derived, that can be assembled to make up what is called “consumer knowledge,” i.e. knowledge about individual consumers or groups of consumers.

Consumer knowledge can be processed in predictive, analytical or decision-making systems to predict or determine behavioral traits of those consumers, so that individuals or groups can be targeted and uniquely addressed for future commercial transactions. Deplorably, consumer knowledge is also a tool which, in the wrong hands or used for nefarious aims, can inflict great harm on financial and commercial institutions. The abuse of consumer knowledge, without a clear, present solution, is only now being realized.

Among businesses, there is a range of attitudes regarding the handling of consumer knowledge. Some businesses carefully protect the consumer knowledge they possess. Others simply view it as a marketable business byproduct to be sold to the highest bidder as quickly as possible. A majority of the roughly 75 million non-poverty American households dislike the ever-creeping increases in public availability of their knowledge, and the concomitant, ever-increasing, threat of abuse and personal attack this implies. Thus, there is a present need for a counter-strategy.

A sharp increase in public and corporate attention to the problem of consumer knowledge abuse will create several opportunities. First, consumers will be looking for a low-effort counter-strategy that will comprehensively “solve the problem” for them; or, at least, move them smartly in the direction of a comprehensive solution. Second, businesses will be looking for a low-effort way to instantaneously address consumer knowledge abuse.

### SUMMARY

This document describes Consumer Knowledge Management (CKM) systems, devices and methods that enable consumers to specifically decide, authorize and communicate their instructions for how they wish to be marketed or sold to by authorized companies. To sustain privacy and dignity in e-commerce transactions, these CKM systems, devices and methods provide consumers with a single trusted entity with which to interact, where the entity is configured to provide security to accumulated consumer knowledge.

In one aspect, security is provided by identity verification, which is accomplished via voice authentication using voice similarity analysis. In another aspect, security is provided by a set of random, continually-changing passwords that can be encrypted and uniquely identified with a fictitious and anonymous user name. Each anonymous user name is uniquely associated with a consumer's real identity that is protected by a set of security measures of a Knowledge Manager (KM), for use with an Anonymous Payment Card (APC) and an Anonymous Internet-email Account. The KM issues a fictitious, “one-time” (e.g. never re-used) APC number and user name to a participating consumer who wishes to attain anonymity, along with a mailing address at a “Ghost Shipping” location, such that packages sent to the consumer can be re-packaged and re-shipped to the consumer without the seller or the shipper knowing the consumer's real identity.

In yet another aspect, consumers input information into a set of “rules” or thresholds, indicating to which payment transactions they wish to be alerted, and a notification method of how they want to be alerted. Various types of payment transactions are categorized and summarized into a summary that provides cardholders with an overall view of their purchase activity (a transaction profile), and that highlights unusual transactions which fall outside of their normal transaction profile. A cardholder decides and communicates certain payment restrictions that block specific types of transactions based on the transaction type, location, merchant type, amount, or any combination thereof.

In yet another aspect, terms (e.g. interest rate, credit limit, etc.) of a credit arrangement, such as using the APC as a credit card, are dynamically and periodically adjusted (i.e. from month-to-month) based on their then-current risk profile as measured by a predictive credit score such as the FICO® score. The adjustments can also be based on input from the cardholder about which term(s)—e.g. credit limit, interest rate or other features—are to be given higher priority for qualifying for better terms as their risk profile improves.

The details of one or more embodiments are set forth in the accompanying drawings and the description below. Other features and advantages will be apparent from the description and drawings, and from the claims.

### BRIEF DESCRIPTION OF THE DRAWINGS

These and other aspects will now be described in detail with reference to the following drawings.

FIG. 1 illustrates a consumer knowledge management system.

FIG. 2 is a functional block diagram of a Knowledge Manager system.

FIG. 3 is a flowchart of a secure commerce process according to an embodiment.

Like reference symbols in the various drawings indicate like elements.

### DETAILED DESCRIPTION

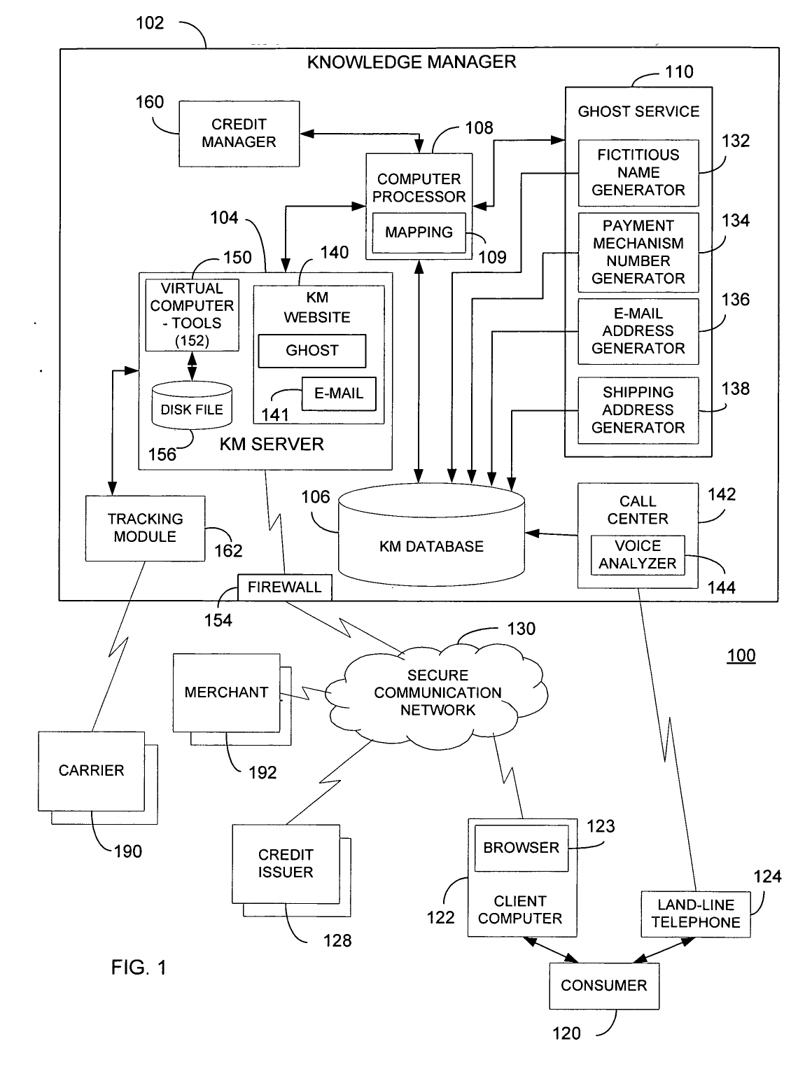

This document describes Consumer Knowledge Management (CKM) systems and methods. As shown in FIG. 1, a CKM system 100 includes a Knowledge Manager (KM) 102 that hosts or controls one or more servers 104 and one or more databases 106. The KM 102 also includes a computer processor 108 that runs various software components for executing business and security processes on consumer knowledge information stored in the database 106, and for executing business processes with consumers 120 via client computer modules 122 running a browser 123 or similar application communicating with the server(s) 104 over a secure communication network 130 such as the Internet.

The KM 102 is associated with a KM website 140 that is served to consumers 120 via the one or more servers 104. The KM website 140 allows consumers 120 to register as CKM participants in a comprehensive line of KM products and services provided by various software components. To become a participant, a consumer 120 accesses the KM website 140 in a registration session to register, as described below. The KM website 140 solicits various basic consumer information from the consumer 120 such as name, address, telephone number, date of birth, etc. The consumer 120 then follows up the registration session with a telephone call to a call center 142, using a telephone 124 such as a landline or other secure telephone. The telephone call with the call center 142 is recorded at the call center 142 and stored in the database 106. The recording is accessed from the database 106 and used by the call center 142 during future telephone contacts with the consumer 120 to verify, via voice similarity analysis by a voice analyzer 144 that a person on a telephone call is the actual consumer 120. The voice analyzer 144 can include hardware and software to record, play, and compare high-fidelity digitized voice files. All calls to the call center 142 can be recorded.

KM Internet and E-Mail Account

The KM website registration session includes the following steps. First, a consumer 120 accesses (from their personal or authorized client computer) the KM website 140 from an authorized client computer 122, such as a personal or work desktop or laptop computer, to begin an encrypted session. During the encrypted session the consumer 120 is asked to reveal consumer knowledge, i.e. information about themselves that will support both the ability of the KM 102 to verify the consumer's identity, as well as the ability of the KM 102 to properly carry out CKM functions for consumer and (should they wish) for their household.

Following the on-line registration process, the KM 102 executes an automated verification process of the consumer knowledge that has been provided. If this verification is suspect, no further action is taken and the consumer knowledge information obtained is placed into a file of the database 106 related to suspicious registration attempts. If the consumer 120 re-contacts the call center 144 after not hearing back from the KM 102, then their registration can be reconsidered on a special-handling basis.

If the automated verification process is successful, the consumer 120 is sent a hardcopy letter, preferably via U.S. Mail, inviting them to complete their registration by calling the KM 102 using their telephone (i.e. land-line or other secure phone) and, for security and further verification, using Caller-ID. The registration call is audio recorded with very high fidelity, and during the call, a KM Consumer Services Representative (CSR) will ask a number of further questions of the consumer 120 and complete that consumer's 120 registration. Registration as a KM participant can cost a fee, including an initial fee, and the payment of the fee can be made by the consumer 120 using a credit card or other electronic payment system. The consumer 120 may be asked to give the KM 102 authorization to check the credit of the consumer 120 and the viability of a selected payment mechanism.

Other automated verification techniques can be applied to further increase confidence that this consumer is indeed the person they claim to be. Finally, all future telephone contacts (which are always required to be calls to the KM 102 by the consumer 120 themselves, from a secure phone connection associated with the consumer 120) will be preceded by a brief hold during which the voice analyzer 144 or KM CSR reviews (for a few seconds) the reference tape of the consumer's 120 voice. The CSR will then greet the consumer (all calls will be recorded and retained for reasonable periods, both for quality control purposes and in case the recording is someday needed in the prosecution of a criminal attempting to impersonate a consumer) and verify that the voice seems to match. Once the registration process is completed, the consumer is thereafter allowed into the inner sanctum of the KM website 140, i.e. secure web pages that are accessible by registered and verified consumers 120.

Once the consumer 120 has become a CKM participant, they are provided with a menu of products and services from which to select from their account on the KM website 140. These include: registering for a financial attack and identity theft protection and alerting service, purchasing a variety of consumer financial training products, registering to consider authorization of marketing and sales approaches, and authorization of transmittal of selected marketing and sales approaches. A CKM participant can also participate in anonymous electronic commerce products and services, as described more fully below.

Ghost Service

The consumer 120 can apply for and participate in a KM ghost service 110. Consumers 120 who apply for the ghost service 110, and who meet the requirements for participation, receive an Anonymous Internet/E-mail Account (AIEA) and/or an Anonymous Payment Card (APC). The AIEA allows a consumer 120 to browse the Internet and send/receive e-mail anonymously, while the APC allows the consumer 120 to execute e-commerce transactions via the Internet securely and anonymously. The AIEA includes at least a randomly-generated and fictitious name and e-mail address, while the APC includes at least a randomly-generated and fictitious name, payment card number, and shipping address. The AIEA can be provided together or separately.

Each time the consumer 120 logs onto the KM website 140 or onto their e-mail account 141 (accomplished by first going to the KM website 140), the ghost service 110 randomly generates a unique, fictitious, and single-use name, payment card number, shipping address, and e-mail return address (“ghost account information”). For example, a ghost e-mail address is generated by an e-mail address generator 136. The ghost account information changes upon each new session by the consumer 120, however, e-mail that has been addressed to all previsou ghost e-mail addresses of that consumer 120 can be accumulated in a file in the database 106 and accessible by that ghost service participant consumer 106.

Each time a ghost service participant visits their account at the KM website 140, they are issued a new virtual computer 150, a software module executed in the KM 102 and operated remotely through the consumer's client computer 122. The virtual computer 150 provides web-based services such as software tools 152, including utilities and applications (e.g. Microsoft Internet Explorer, Microsoft Office, Adobe Acrobat, Reader, and Photoshop, etc.), and is associated with a disk file 156 for storing the utility and application software 152 and 154, files (program files and data files) and web-pages. The disk file 156 can be a separate memory structure than the database 106, or reside within the database 106.

Consumer-defined software configuration information (i.e. user setup data) is also stored in the disk file 156. Each time a new session is started, only the software tools 152 are started, based on the configuration information. All other programs (e.g., virus programs, worms, pop-ups, banners, trojans, downloads, applets, etc.) are completely purged and discarded at the end of each prior session. Only program files created and stored by the user are allowed to be accessed by any running program from the consumer's 120 disk file 156. These safeguards, along with a firewall 154 at the interface to the Internet or secure communication network 130, minimize a probability of the consumer's 120 computer 122 being successfully attacked and the associated consumer knowledge compromised.

The virtual computer 150 used by the ghost service participant is automatically “discarded” at the end of each session. Also, the participant can optionally, at any time, start a new session and/or purge their disk file 156 by simply pushing a button on their computer or on a graphical user interface associated with their computer. This immediately provides them with a completely “fresh” virtual computer 150 and/or disk file 156.

The virtual computer 150 can include a restriction where the only information that is ever routed back to the ghost participant's client computer 122 are copies of the “screen” or graphical user interface of the virtual computer 150. Downloads, file transfers (FTPs), etc. are not allowed because there is presently no way to make such entities safe for the client computer 122. If downloads are needed by the consumer 120, these can be obtained directly via the client computer 122 and browser 123 from the desired website, and outside of the virtual computer 150.

Anonymous Payment Card

A ghost service participant can shop online for products and services using their APC. The APC uses an account number randomly generated by a payment mechanism number generator 134. The account number can look like a standard payment mechanism account number (i.e. 16 digit credit card number), but may take any form, to include any alphanumeric characters or symbols. Charges made to the APC are immediately debited by a credit manager 160 of the KM 102 against an existing credit card or other electronic payment mechanism provided by a credit issuer 128 and specified by the consumer 120. The existing credit card or other electronic payment mechanism can also be issued to the consumer 120 by the KM 102, where the KM 102 is effectively the credit issuer 128. Although the charges made against the APC show up on a monthly bill or other electronic payment statement provided by the credit issuer 128, these charges may list the KM 102 as the seller.

Charges made against the APC can be acquired by another credit issuer 128 under terms of an agreement with the KM 102. The details of these charges are secured by the KM 102 as part of its CKM responsibility. Preferably, the APC is embodied as a card device such as a credit or debit card. However, the APC may also be embodied as any other type of electronic payment mechanism.

The APC is issued to consumers 120 who qualify. Charges to the APC are immediately debited by the credit manager 160 against the payment mechanism that the consumer has designated when joining. Thus, payment to the KM 102 is immediate and assured, mitigating any risk for the KM 102. The name associated with the APC is a contrived name generated by a fictitious name generator 132. For example, a consumer 120 might be assigned the name “Pluto Chicago.” These names can be selected from a database of component words that are familiar and easy to remember, but which are unlikely to occur together as names of real people.

With each renewal of the APC, or logon to the KM website, a list of false addresses as generated by a shipping address generator 138 is sent to the consumer 120. If needed, more addresses can be obtained by the consumer 120 at any time from the shipping address generator via the KM website 140. Each address is used only once and is then removed from the list of generated addresses. A predetermined fee can be charged periodically to the consumer 120 for use of the APC. Further, a nominal surcharge can be charged on all transactions executed by the APC.

The APC will have a salutary effect on Internet-based e-commerce. Consumers can buy products and services from almost any Internet source, in a totally secure manner. The KM 102, via the credit manager 160, can implement a number of payment policies. For example, payment authorization can be withdrawn by the credit manager 160 in the event that a shipment is not made within a predetermined time, i.e. 24 hours, after a card is debited. Additionally, with the cooperation of a parcel tracking service of a carrier 190 such as UPS or FedEX, the KM 102 can include a tracking module 162 configured to track shipment of a parcel and whether a parcel was in fact shipped by the merchant to the consumer 120 whose electronic payment mechanism has been debited.

The APC does not compete with any existing credit card or other electronic payment mechanism. It has a very low balance limit (i.e. essentially zero), since the KM 102 immediately debits the consumer's registered electronic payment mechanism after every transaction. Also, use of the APC will often significantly increase the usage of the consumer's 120 registered electronic payment mechanism, since the consumer will be making more purchases via the Internet. Further, use of the APC will open up new opportunities for credit issuers 128 such as banks and companies in many other industries, such as insurance, retail sales, retail product manufacturing, pharmas, etc., to more accurately and inexpensively cross-sell to consumers since the KM 102 has panoramic access to knowledge about the consumer 120 and, assuming the consumer 120 gives their permission, can act as a high-success-rate ‘matchmaker’ between merchants and consumers 120.

Anonymous Shipping/Mailing

When a ghost service participant consumer makes an online or telephone purchase using their APC, they can opt to have the merchandise shipped to them anonymously using a ghost shipping service supplier (GSSS), essentially a carrier 190 under a ghost service contract with the KM 102. To do this, the consumer 120 provides an online merchant 192 with their ghost account information (i.e. KM-generated one-time, single-use fictitious name, address, and APC account number). Purchase authorization is carried out by KM 102 affiliates in communication with the KM 102, or via the credit manager 160.

In an exemplary embodiment, the KM 102 contracts with one or more carriers 190 to physically deliver parcels to consumers 120. When a parcel containing the merchandise reaches a hub of a GSSS, the fictitious consumer name and consumer address are securely converted to the consumer's 120 actual name and preferred shipping address. In a particular embodiment, the GSSS communicates with the KM via a secure, preferably high bandwidth, connection. The GSSS transmits the ghost account information to the computer processor 108 of the KM 102. The computer processor 108 includes a mapping module 109 that maps the data of the ghost account information to the consumer's actual name and preferred shipping address, which is transmitted back to a relabeling machine (not shown) at the hub of the GSSS. Then, the relabeling machine pastes on an overlabel with the actual name and preferred shipping address. The ghost shipping service eliminates all release of consumer knowledge to on-line merchants—thereby eliminating a major avenue of financial attack and consumer knowledge abuse.

Ghost service participants can roam the Internet and send and receive e-mail anonymously. Ghost service accounts are accorded high-level, advanced security protection, as well as additional specific privacy safeguards, including the purging of any consumer identification information from all outgoing transmissions (unless overridden by the consumer themselves). Ghost participants who desire an even higher level of protection can obtain an encryption disk (preferably in the form of a DVD or CD-ROM) that includes truly random, constantly-changing passwords, which are uniquely created for a consumer 120 using a true random noise source. This disk, which can be replaced every time the consumer's 120 usage of the last disk brings it close to the point where security could be compromised, ensures that, short of direct tapping of their computer, all communications between the consumer and their KM account are secure from eavesdropping and intercept.

The KM 102 can be configured to charge some ghost service participants a monthly fee for the services and products they use. Alternatively, the KM 102 can be configured to enable consumers 120 to choose to allow release of precisely specified knowledge about them to precisely defined classes of users of that knowledge in return for a reduction, or in some cases, elimination of their monthly fees.

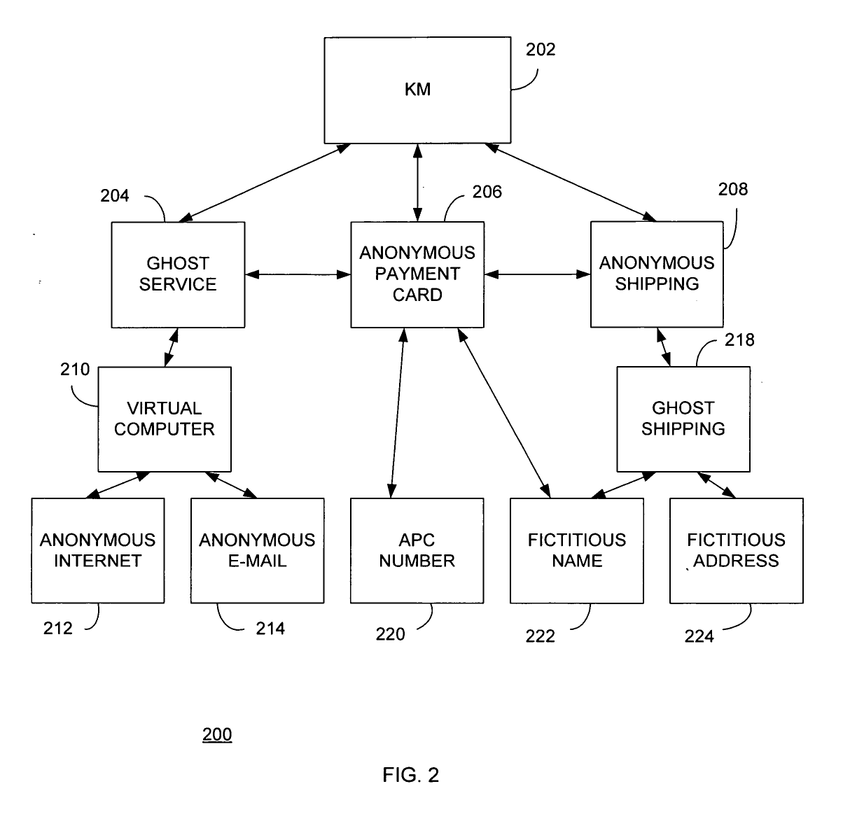

FIG. 2 is a functional block diagram of a CKM system 200 illustrating a hierarchy of services provided by an alternative embodiment of a CKM system 200. The CKM system 200 includes a KM 202. The KM 202 is configured to provide secure e-commerce by providing a ghost service 204, an anonymous payment card (APC) service 206, and an anonymous shipping (AS) service 208.

Functionally speaking, the ghost service 204 includes a virtual computer 210 that provides anonymous internet access 212 and anonymous e-mail 214. The anonymous internet access 212 enables access by a consumer to any web page or web site via the virtual computer 210, where the identity of the consumer or their personal computer is not known by the accessed web page or web site. The anonymous e-mail 214 provides a fictitious e-mail account via the virtual computer 210 to enable e-mail communication by the consumer to any other e-mail account via the virtual computer 210, thereby keeping the consumer anonymous.

The APC service 206 provides an APC number 220, which is randomly generated and mapped to an actual payment mechanism account number provided by a consumer. The APC service 206 uses the APC number 220 to issue credit and make purchases on behalf of the consumer so that the consumer need not use their own actual payment mechanism account number. The APC service 206 also provides a fictitious name 222, so that the actual name of the consumer is not revealed during such purchases and the consumer remains anonymous.

The GS service 208 provides ghost shipping 218 of any purchased goods so that the actual address and actual name of a consumer is not revealed. The ghost shipping 218 uses the fictitious name 222 (either the same fictitious name used for the APC service 206 or a different fictitious name), as well as a fictitious address 224. The fictitious name 222 and fictitious address 224 can be used by a merchant and selected carrier to ship products to the consumer, where en route the fictitious name 222 and fictitious address 224 are mapped by the ghost shipping 218 to a consumer's actual name and preferred receipt address. Accordingly, the merchant will not know the consumer's actual name and address.

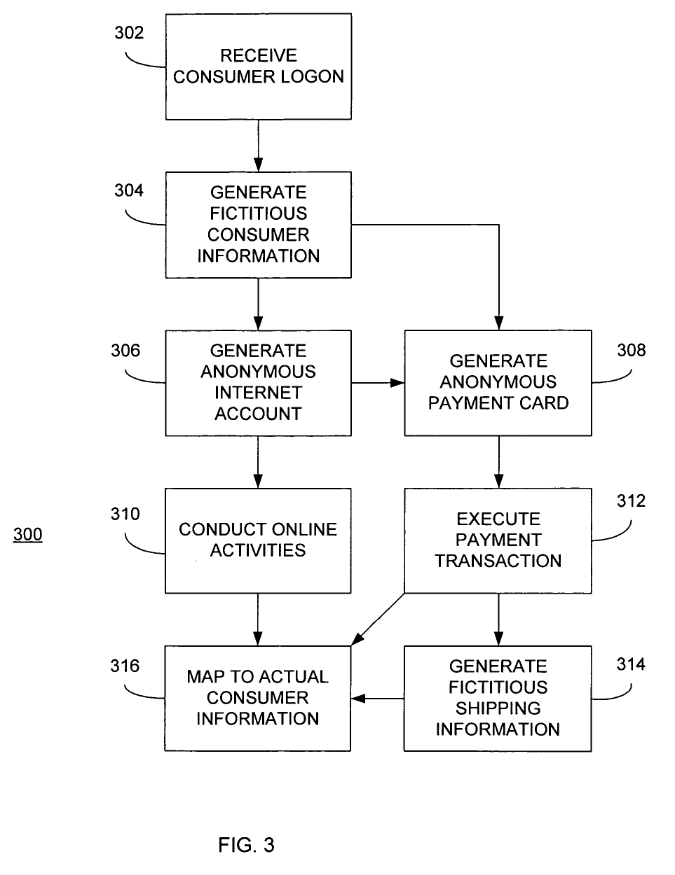

FIG. 3 is a flowchart of a secure e-commerce process 300 that can be executed by a knowledge manager (KM). At 302, the KM receives consumer logon information, such as name, address, actual payment mechanism information (credit/debit card number), and other validating information such as birth date, social security number, etc. At 304, the KM generates fictitious consumer information, such as a fictitious and randomly or semi-randomly-generated name, address, account number, and e-mail address.

At 306, the KM uses at least a portion of the fictitious consumer information to generate an anonymous internet account and virtual computer, with which to conduct online activities 310 such as using applications, e-commerce, web “surfing,” and e-mailing, all using the fictitious consumer information. With the anonymous internet account, or independently, the KM uses at least the fictitious name and a fictitious account number to generate an anonymous payment card, at 308. The anonymous payment card is used to execute payment transactions 312 on e-commerce activity, so that the consumer's actual information is neither known by a merchant nor used in the e-commerce activity.

At 314, the KM generates a fictitious shipping address and fictitious consumer name, for use in shipping any purchased goods to the actual consumer anonymously and securely. At 316, the KM maps any fictitious consumer information to the associated actual consumer information, as necessary. For instance, if the consumer has made a purchase with the anonymous payment card, at 308 and 312, the KM will map the anonymous payment card number to an actual payment mechanism account number provided by the consumer. Or, a shipment via the fictitious shipping information is mapped to a consumer's actual name and actual desired receiving address. Accordingly, all Internet transactions and e-commerce are handled securely and/or anonymously for a consumer by the KM.

The KM and the communication scenarios described herein, and their various modifications, are not limited to use with any particular hardware and/or software; they may find applicability in any computing or processing environment and with any type of machine that is capable of running machine-readable instructions. All or part of the KM or the communication scenarios can be implemented in digital electronic circuitry, or in computer hardware, firmware, software, or in combinations thereof.

All or part of the KM or the communication scenarios can be implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps associated with the KM can be performed by one or more programmable processors executing one or more computer programs to perform the functions of the KM. The method steps can also be performed by, and the KM can be implemented as, special purpose logic circuitry, e.g., an FPGA (field programmable gate array) and/or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only storage area or a random access storage area or both. Elements of a computer include a processor for executing instructions and one or more storage area devices for storing instructions and data.

Generally, a computer will also include, or be operatively coupled to receive data from, or transfer data to, or both, one or more mass storage devices for storing data, e.g., magnetic, magneto-optical disks, or optical disks. Information carriers suitable for embodying computer program instructions and data include all forms of non-volatile storage area, including by way of example, semiconductor storage area devices, e.g., EPROM, EEPROM, and flash storage area devices; magnetic disks, e.g., internal hard disks or removable disks; magneto-optical disks; and CD-ROM and DVD-ROM disks.

All or part of the KM, the communication scenarios or the CKM system can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the KM or the communication scenarios, or any combination of such back-end, middleware, or front-end components. The components of the system can be interconnected by any form or medium of digital data communication, e.g., a communication network. Examples of communication networks include a LAN and a WAN, e.g., the Internet.

Method steps associated with the KM or process 300 can be rearranged and/or one or more such steps can be omitted to achieve the same, or similar, results to those described herein. The KM or the communication scenarios may be fully automated, meaning that it operate without user intervention, or interactive, meaning that all or part of the KM or the communication scenarios may include some user intervention.

Although a few embodiments have been described in detail above, other modifications are possible. The logic flows described herein do not require the particular order shown, or sequential order, to achieve desirable results.

1. A secure commerce method comprising:
generating an anonymous payment mechanism account number;
associating the anonymous payment mechanism account number with an actual payment mechanism account number received from a consumer over a secure network and stored in a database; and
issuing commercial credit to the consumer via the anonymous payment account number.

2. A secure commerce method in accordance with claim 1, further comprising providing a debit against the commercial credit issued to the consumer via the anonymous payment mechanism account number according to a commercial transaction initiated by the consumer.

3. A secure commerce method in accordance with claim 2, further comprising mapping the debit from the anonymous payment mechanism account number to the actual account number.

4. A secure commerce method in accordance with claim 3, further comprising providing a debit against a credit associated with the actual payment mechanism account number based on the debit provided against the credit issued to the consumer via the anonymous payment mechanism account number.

5. A secure commerce method in accordance with claim 1, wherein the actual payment mechanism account number is associated with an actual payment mechanism.

6. A secure commerce method in accordance with claim 5, wherein the actual payment mechanism is a credit card.

7. A secure commerce method in accordance with claim 1, further comprising:
generating a fictitious name for the consumer; and
associating the fictitious name with the anonymous payment mechanism account number.

8. A network-based, secure commerce system comprising:
a knowledge manager comprising one or more servers and one or more databases, at least one of the servers being responsive to a registration program executed by a consumer on a client computer, the registration program submitting consumer registration data to at least one of the databases over the network; and
a call center comprising a telephone network connected with the knowledge manager, and configured to receive follow-up consumer registration data from a telephone associated with the consumer.

9. A system in accordance with claim 8, wherein the call center further includes a voice analyzer, and wherein the follow-up consumer registration data includes a voice file from the consumer.

10. A system in accordance with claim 9, wherein the voice analyzer is configured to analyze the voice file and determine whether a voice on the voice file is the voice of the consumer.

11. A system in accordance with claim 8, wherein the registration program includes an encrypted session.

12. A system in accordance with claim 8, wherein the knowledge manager further includes a verification program configured to verify an identity of the consumer based at least in part on the consumer registration data.

13. A system in accordance with claim 8, wherein the knowledge manager includes an anonymous payment mechanism generator configured to:
generate an anonymous payment mechanism account number;
associate the anonymous payment mechanism account number with an actual payment mechanism account number received from the consumer over the network and stored in at least on of the databases; and
issue commercial credit to the consumer via the anonymous payment account number.

14. A system in accordance with claim 13, wherein the actual payment mechanism account number is a credit card number issued to the consumer from a credit issuing entity.

15. A system in accordance with claim 8, wherein the knowledge manager further includes an anonymous internet/e-mail account generator that is configured to generate an anonymous internet and electronic mail account for the consumer for anonymous and secure commercial transactions by the consumer over the network.

16. A system in accordance with claim 13, wherein the knowledge manager further includes a ghost service program that is configured to randomly generate a unique, fictitious and single-use name and an address for the consumer, and the anonymous payment mechanism account number associated with the consumer.

17. A system in accordance with claim 16, wherein the address includes a physical address.

18. A system in accordance with claim 16, wherein the address includes an electronic mail address.

19. A secure commercial transaction system comprising:
an anonymous payment mechanism configured to:
generate an anonymous payment mechanism account number;
associate the anonymous payment mechanism account number with an actual payment mechanism account number received from the consumer over the network and stored in at least on of the databases; and
issue commercial credit to the consumer via the anonymous payment account number.
an anonymous internet/e-mail account generator configured to:
generate an anonymous internet and electronic mail account for the consumer, the account including a unique, fictitious and single-use name and an address for the consumer.

20. A system in accordance with claim 19, further comprising a card, the card including a representation of the anonymous payment mechanism account number.

21. A system in accordance with claim 20, wherein the card further includes an identifier associated with the consumer.

22. A system in accordance with claim 19, further comprising a ghost shipping service that includes a database mapping the unique, fictitious and single-use name and address for the consumer to a real name and address for the consumer.
